(19) United States
(12) Patent Application Publication
(10) Pub. No.: US 2026/0140366 A1
(43) Pub. Date: May 21, 2026

(54) VIBRATION DEVICE AND IMAGING DEVICE

(71) Applicant: Murata Manufacturing Co., Ltd., Nagaokakyo-shi (JP)

(72) Inventors: Yuka Tanaka, Nagaokakyo-shi (JP); Noritaka Kishi, Nagaokakyo-shi (JP); Shigehisa Yago, Nagaokakyo-shi (JP)

(21) Appl. No.: 19/446,051

(22) Filed: Jan. 12, 2026

Related U.S. Application Data
(63) Continuation of application No. PCT/JP2024/016934, filed on May 7, 2024.

(30) Foreign Application Priority Data
Aug. 7, 2023 (JP) 2023-128571

(51) Int. Cl. G02B 27/00; H04N 23/52

(52) U.S. Cl. CPC G02B 27/0006; H04N 23/52

(57) ABSTRACT

A vibration device and an imaging apparatus is provided that is configured to prevent foreign matter from adhering to a portion thereof that may cause a decrease in the vibration performance. The vibration device includes an outermost lens that transmits light of a predetermined wavelength; a vibrator that contacts the outermost lens and vibrates the outermost lens; a piezoelectric element on the vibrator; a leaf spring and a retainer that extend outward from a side wall of the vibrator that is formed as a tubular body; and a cover that covers the vibrator and at least part of the leaf spring.

### CROSS REFERENCE TO RELATED APPLICATIONS

This application is a continuation of PCT Application No. PCT/JP 2024/016934, filed May 7, 2024, which claims priority to Japanese Patent Application No. 2023-128571, filed Aug. 7, 2023, the entire contents of each of which are hereby incorporated by reference in their entireties.

### TECHNICAL FIELD

The present disclosure relates to a vibration device and an imaging apparatus.

### BACKGROUND

These days, a vehicle controls a safety system and performs driver assistance control by using images obtained by an imaging apparatus. An imaging apparatus is thus provided on the front part or the rear part of a vehicle. Such an imaging apparatus is usually disposed outside a vehicle and foreign matter, such as raindrops (droplets of water), mud, dust, and the like, adheres to a light-transmitting member (e.g., a protective cover or a lens) that covers the imaging apparatus.

If foreign matter adheres to the light-transmitting member, it may appear in an image captured by the imaging apparatus, thereby failing to obtain a clear image. Japanese Unexamined Patent Application Publication No. 2017-170303 discloses a droplet removal device (e.g., a vibration device) installed in an imaging apparatus. This droplet removal device vibrates a light-transmitting member to remove foreign matter adhering to the surface of the light-transmitting member.

In the vibration device disclosed in Japanese Unexamined Patent Application Publication No. 2017-170303, a piezoelectric element is attached to a flange of the light-transmitting member and the light-transmitting member is vibrated. In this vibration device, to fix the piezoelectric element to the flange, the piezoelectric element is enclosed by a droplet-proof seal and the droplet-proof seal is fixed to a base frame. Because of this configuration, vibration may be transmitted from the droplet-proof seal, which directly contacts the piezoelectric element, to the base frame. This may lower the vibration performance.

Additionally, in the vibration device disclosed in Japanese Unexamined Patent Application Publication No. 2017-170303, foreign matter, such as water and dust, may adhere to the droplet-proof seal. The foreign matter adhering to the droplet-proof seal may interfere with the vibration of the piezoelectric element and lower the vibration performance.

### SUMMARY OF THE INVENTION

Accordingly, in view of the foregoing, a vibration device and an imaging apparatus are provided according to the present disclosure that are configured to prevent or minimize foreign matter from adhering to a portion that may cause a decrease in the vibration performance.

In an exemplary aspect, a vibration device is provided that includes a light-transmitting member that transmits light of a predetermined wavelength; a vibrator having a tubular body and contacting the light-transmitting member and vibrates the light-transmitting member; a piezoelectric element provided on the vibrator; an extending section that extends outward from a side wall of the vibrator; and a cover that covers the vibrator and at least part of the extending section.

Moreover, an imaging apparatus is provided that includes the above-described vibration device and an imaging device. The imaging device is arranged such that the light-transmitting member is positioned in a viewing direction of the imaging device.

According to the exemplary aspects of the present disclosure, a cover is provided the prevents or minimizes foreign matter from adhering to a vibrator and at least part of an extending section, thereby preventing a decrease in the vibration performance.

### BRIEF DESCRIPTION OF DRAWINGS

FIG. 1 is a perspective view of an imaging apparatus according to a first exemplary embodiment.

FIG. 2 is a half-sectional view of a vibration device according to the first exemplary embodiment.

FIG. 3(a) and 3(b) show a graph and a schematic view for explaining the relationship between the displacement and the distance from a start point.

FIG. 4 is a schematic view for explaining the displacement occurring in the vibration device of the first exemplary embodiment.

FIG. 5(a) and 5(b) show a graph and a perspective view for explaining the relationship between the amount of displacement of an outermost lens (light-transmitting member) and a load.

FIG. 6 is a graph for explaining the relationship between the amount of displacement of the outermost lens (light-transmitting member) and the Young's modulus of an intermediate member.

FIG. 7 is a half-sectional view of a vibration device according to a first modified example.

FIG. 8 is a half-sectional view of a vibration device according to a second modified example.

FIG. 9 is a half-sectional view of a vibration device according to a third modified example.

FIG. 10 is a half-sectional view of a vibration device according to a fourth modified example.

FIG. 11 is a half-sectional view of a vibration device according to a fifth modified example.

FIG. 12 is a half-sectional view of a vibration device according to a sixth modified example.

FIG. 13 is a sectional view illustrating a retaining position of a cover.

FIG. 14 is a sectional view illustrating another retaining position of the cover.

FIG. 15 is a half-sectional view of a vibration device according to a second exemplary embodiment.

FIG. 16 is a schematic view for explaining the displacement occurring in the vibration device of the second exemplary embodiment.

FIG. 17 is a half-sectional view of a vibration device according to a modified example of the second exemplary embodiment.

FIG. 18 is a half-sectional view of a vibration device according to a third exemplary embodiment.

FIG. 19(a) to 19(c) show graphs for explaining the relationship between the amount of displacement of the outermost lens (light-transmitting member) and the dimensions of an intermediate member.

FIG. 20 is a half-sectional view of a vibration device according to a modified example of the third exemplary embodiment.

FIG. 21 is a half-sectional view of a vibration device according to a fourth exemplary embodiment.

FIG. 22(a) and 22(b) show perspective views of a vibration device according to a fifth exemplary embodiment.

### DETAILED DESCRIPTION OF EMBODIMENTS

An imaging apparatus of the present disclosure will be described below in detail with reference to the drawings. Identical or corresponding elements are designated by like reference numeral in the drawings. The imaging apparatus, which will be discussed below, can be used for a vehicle, for example, and is configured to vibrate a light-transmitting member (outermost lens, for example) to remove foreign matter adhering to the surface of the light-transmitting member. It should be appreciated that the purpose of use of the imaging apparatus is not limited to a vehicle. For example, the imaging apparatus may be applicable to a security camera, a drone, or another machine.

### First Exemplary Embodiment

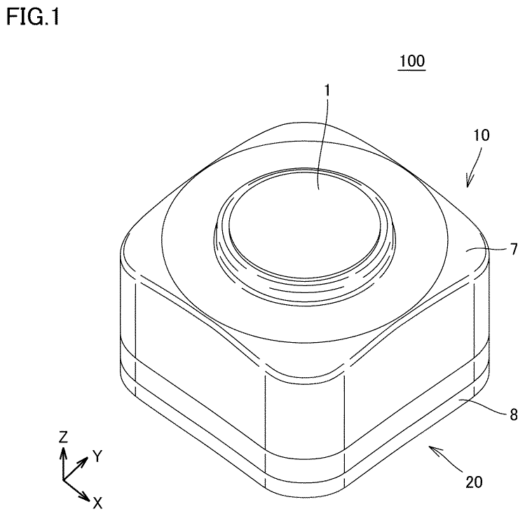

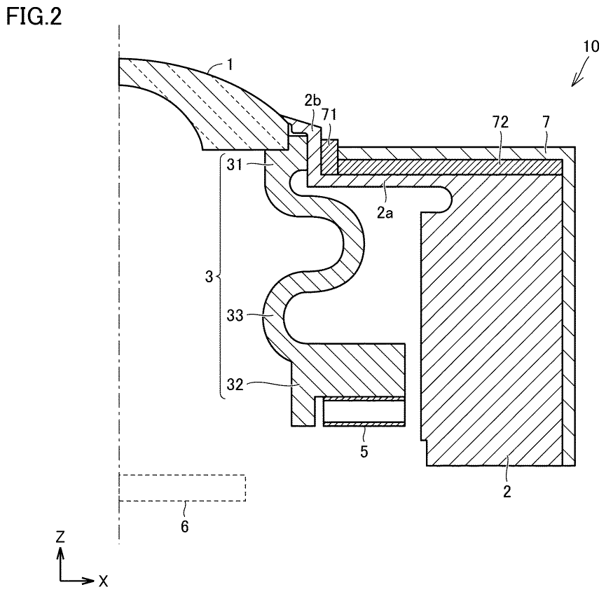

FIG. 1 is a perspective view of an imaging apparatus 100 according to a first exemplary embodiment. FIG. 2 is a half-sectional view of a vibration device 10 according to the first exemplary embodiment. For purposes of this disclosure, the X, Y, and Z directions in the drawings represent the lateral direction, depth direction, and height direction, respectively, of the imaging apparatus 100. The long dashed dotted line in FIG. 2 indicates a portion of the vibration device 10 passing through its central axis. As shown, the imaging apparatus 100 includes the vibration device 10 and a sensor device 20. The vibration device 10 includes an outermost lens 1, a housing 2, a vibrator 3, a piezoelectric element 5, and a cover 7. The sensor device 20 includes a bracket 8 that holds an imaging device 6. Moreover, the imaging apparatus 100 preferably includes an inner lens between the outermost lens 1 and the imaging device 6, though such an inner lens is not shown.

After the alignment adjustment between the outermost lens 1 and the imaging device 6 is performed, the sensor device 20 is bonded to the vibration device 10, thereby forming the imaging apparatus 100. In an exemplary aspect, the imaging device 6 is an image sensor, such as a CCD (Charge Coupled Device) sensor or a CMOS (Complementary Metal-Oxide-Semiconductor) sensor, for example, and is mounted on a circuit substrate (not shown). On the circuit substrate, not only a semiconductor device, such as a general-purpose IC (Integrated Circuit) or an ASIC (Application Specific Integrated Circuit), that controls the imaging device 6, but also a semiconductor device that generates a signal for driving the piezoelectric element 5, for example, may be mounted. The circuit substrate is fixed to the bracket 8 at a position at which the alignment adjustment between the imaging device 6 and each of the outermost lens 1 and the inner lens (not shown) has been performed. In an exemplary aspect, the bracket 8 can be made of aluminum (A5052), for example.

The outermost lens 1 is a light-transmitting member that is configured to transmit light of a predetermined wavelength (such as a wavelength of visible light and a wavelength receivable by an imaging device). Examples of the outermost lens 1 are borosilicate crown glass (BK7), quartz glass, crown glass, flint glass, and a convex meniscus lens. The vibration device 10 may use a transparent member, such as a protective cover, instead of the outermost lens 1 in an alternative aspect. The protective cover can be made of glass or a resin, such as transparent plastics.

An end portion of the outermost lens 1 contacts an end portion of a leaf spring 2a extending from the housing 2. The end portion of the leaf spring 2a is a retainer 2b. The retainer 2b contacts the outermost lens 1 and the vibrator 3. An adhesive, for example, intervenes between the retainer 2b and each of the outermost lens 1 and the vibrator 3. The housing 2, the leaf spring 2a, and the retainer 2b may be integrally formed or be separately formed. In the vibration device 10, the vibrator 3 contacts the outermost lens 1 to vibrate the outermost lens 1. The housing 2 and the vibrator 3 can be made of stainless steel (SUS304, SUS420, or SUS440), for example.

As shown in FIG. 2, the vibrator 3 is formed as a tubular body and includes a connecting section 31 (e.g., a first portion) that contacts the outermost lens 1, a vibrating section 32 (e.g., a second portion) that accommodates the piezoelectric element 5, and a support section 33 (e.g., a third portion) that links the connecting section 31 and the vibrating section 32. The cross-sectional shape of the support section 33 is an S-shape. An inner lens, which is not shown, may be disposed inside the tubular body of the vibrator 3.

The connecting section 31 is a cylindrical portion that extends in the axial direction (Z direction) of the tubular body. An end portion of the connecting section 31 contacts the peripheral portion of the outermost lens 1, so that the connecting section 31 can transmit the vibration of the vibrator 3 to the outermost lens 1. Moreover, a depression is formed in the connecting section 31 to stably hold the outermost lens 1 in the radial direction (X and Y directions) of the tubular body.

The vibrating section 32 is a portion that is configured to vibrate together with the piezoelectric element 5. The vibrating section 32 is thicker than the connecting section 31 and the support section 33. This configuration efficiently transmits the vibration of the piezoelectric element 5 to the outermost lens 1.

The support section 33 is a portion that supports the connecting section 31 and also transmits the vibration of the vibrating section 32 to the connecting section 31. The connecting section 31, vibrating section 32, and support section 33 may be integrally formed or be separately formed in exemplary aspects.

The piezoelectric element 5 is mounted on the surface of the vibrating section 32 opposite the surface of the vibrator 3 in contact with the outermost lens 1. The piezoelectric element 5 is formed in a hollow circular shape and is vibrated by, for example, polarizing in the thickness direction. The piezoelectric element 5 can be made of PZT piezoelectric ceramics. Another type of piezoelectric ceramics, such as (K, Na)NbO₃, may be used. Alternatively, piezoelectric single crystal, such as LiTaO₃, may be used.

The piezoelectric element 5 having a hollow circular shape is vibrated in the radial direction. This vibration is converted into the vibration in the Z direction (e.g., the top-bottom direction in the drawing) by the support section 33 of the vibrator 3, thereby vibrating the outermost lens 1 in the Z direction.

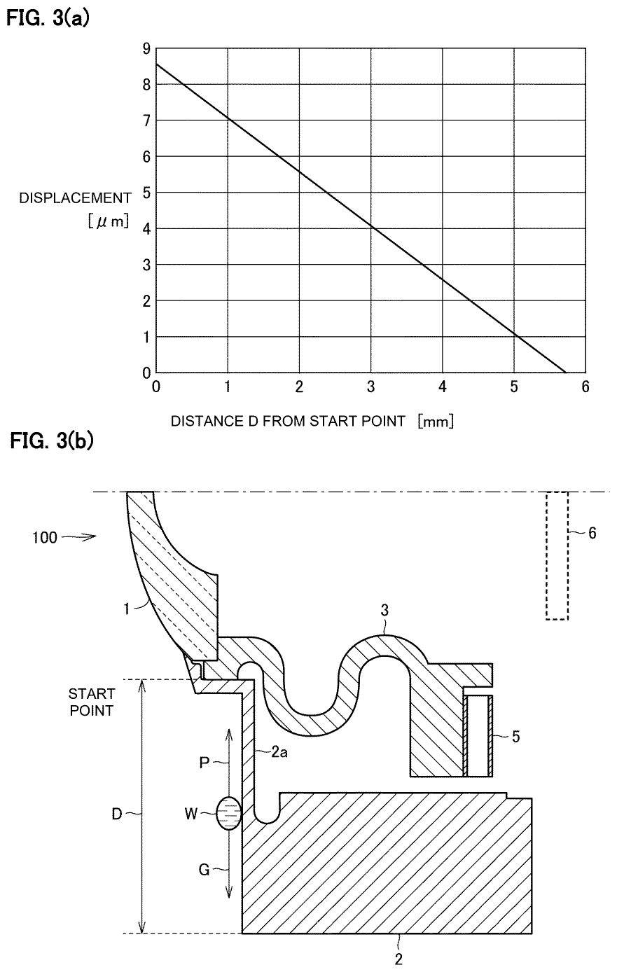

When the outermost lens 1 is vibrated by the vibrator 3, the retainer 2b, which contacts the outermost lens 1 and the vibrator 3, and the leaf spring 2a linked with the retainer 2b are also vibrated. The leaf spring 2a and the retainer 2b are an extending section extending outward from the side wall of the vibrator 3. The displacement of the extending section generated by the vibration of the vibrator 3 becomes smaller farther toward the outward direction. The displacement of the leaf spring 2a and the retainer 2b will be more specifically explained below by assuming that the position at which the vibrator 3 and the retainer 2b contact each other is a start point. FIG. 3(a) and 3(b) show a graph and a schematic view for explaining the relationship between the displacement and the distance from the start point.

As illustrated in FIG. 3(b), the imaging apparatus 100 can be installed on a machine (vehicle, for example) so that the optical axis (indicated by the long dashed dotted line) is positioned at about 90 degrees with respect to the gravity direction (e.g., downward direction in the drawing). Because of this arrangement, foreign matter having a high moisture content, such as raindrops, adhering to the outermost lens 1 and the leaf spring 2a (extending section) moves in the downward direction in the drawing due to gravitational force G. However, when the outermost lens 1 and the leaf spring 2a are displaced due to the vibration of the vibrator 3, the foreign matter W adhering to the leaf spring 2a, which is vibrated with an amount of displacement that does not cause atomization of the foreign matter W, moves in a direction of a larger amount of displacement. The reason for this is as follows. The force that deforms the foreign matter W due to the vibration of the vibrator 3 varies depending on the amount of displacement. This shifts the center of gravity of the foreign matter W, thereby generating the force P that moves the foreign matter W in the direction of a larger amount of displacement.

As shown in FIG. 3(a), the amount of displacement of the leaf spring 2a and the retainer 2b becomes smaller as the distance from the start point is greater. Accordingly, the force P generated in the foreign matter W due to the vibration of the vibrator 3 acts toward the start point, that is, the direction opposite the direction of the gravitational force G. The foreign matter W adhering to the leaf spring 2a thus remains at a position at which the force P and the gravitational force G are balanced with each other. If the foreign matter W keeps remaining on the leaf spring 2a, the vibration of the piezoelectric element 5 may be inhibited by this foreign matter W, which may lower the vibration performance.

To address this issue, the vibration device 10 includes the cover 7 that covers the leaf spring 2a to prevent the adhesion of foreign matter to the leaf spring 2a. The cover 7 is arranged to have a gap to prevent direct contact with the leaf spring 2a, which is vibrated by the vibrator 3, and is retained on the outer surface (surface perpendicular to the leaf spring 2a) of the housing 2. The displacement of the cover 7 does not occur by the vibration of the vibrator 3, so that foreign matter does remain on the surface of the cover 7. As a result, the vibration of the piezoelectric element 5 is not inhibited by foreign matter adhering to the cover 7, and the vibration performance is maintained. It is sufficient that the cover 7 can cover the vibrator 3 and at least part of the leaf spring 2a (extending section), which is displaced by the vibration of the vibrator 3.

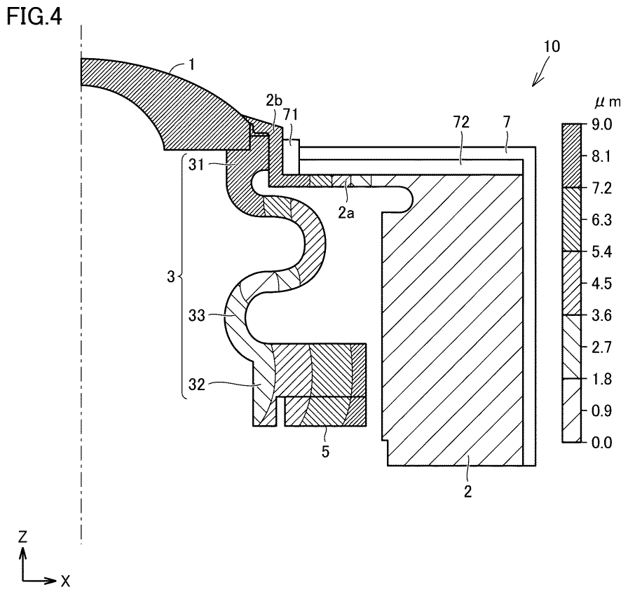

FIG. 4 is a schematic view for explaining the displacement occurring in the vibration device 10 of the first exemplary embodiment. As is seen from FIG. 4, the support section 33 is elastically deformed like a spring, so that the vibrator 3 displaces the outermost lens 1 by a considerable amount in the Z direction. Because of the vibration of the vibrator 3, the leaf spring 2a that contacts the outermost lens 1 is also elastically deformed. As is also seen from FIG. 4, the vibrator 3 has a vibration node N at the center of a portion of the support section 33 whose cross-sectional shape is an S-shape. Due to the vibration of the vibrator 3, the displacement of the outermost lens 1 becomes the largest, while the displacement of the center (e.g., a node) of the support section 33 is small. In FIG. 4, the magnitude of displacement is represented by the density of hatching. A region with denser hatching represents a portion with a larger displacement. The largest displacement occurs at the outermost lens 1, while the smallest displacement is observed at the center of the support section 33 and the housing 2.

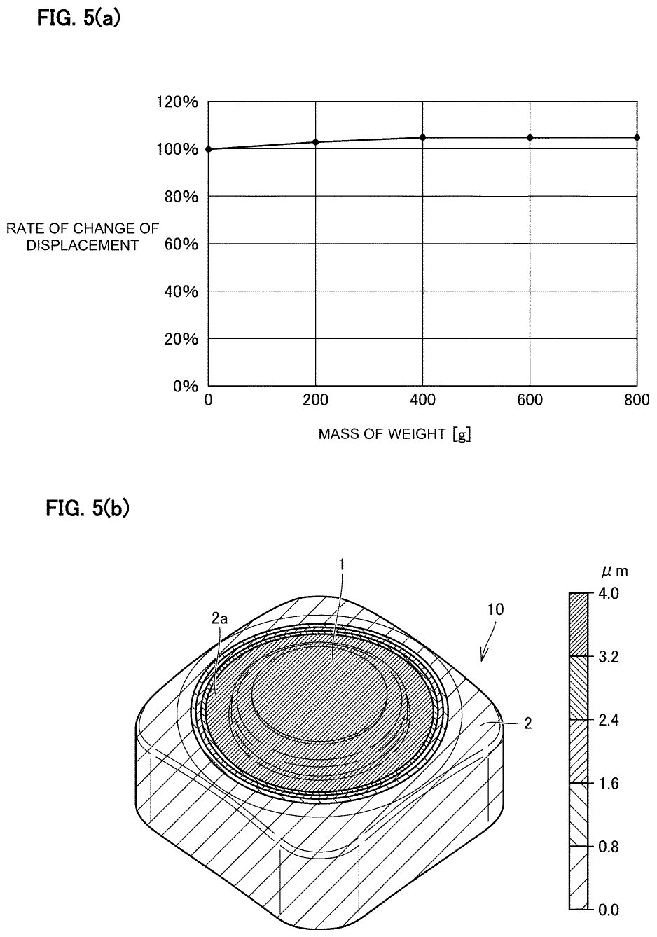

The cover 7 is retained on the housing 2 having the smallest displacement. The condition for a portion that can retain the cover 7 will be explained more specifically. It is necessary that the cover 7 be disposed at a position at which the vibration of the outermost lens 1 is not inhibited by the application of external force. To determine the position of the cover 7 at which the vibration of the outermost lens 1 is not inhibited, the amount of displacement of the outermost lens 1 was examined by applying a load to the four corners of the housing 2 of the vibration device 10. FIG. 5(a) and 5(b) show a graph and a perspective view for explaining the relationship between the amount of displacement of the outermost lens 1 (e.g., a light-transmitting member) and the load.

FIG. 5(a) illustrates a change in the amount of displacement of the outermost lens 1 when a weight of 0 to 800 g was placed at the four corners of the housing 2. In FIG. 5(a), the horizontal axis indicates the mass (g) of the weight, and the vertical axis indicates the rate of change of the displacement when the displacement of the outermost lens 1 with a weight of 0 g is 100%. When weights were placed at the four corners of the housing 2, the displacement of the outermost lens 1 was almost unchanged regardless of the mass of the weight.

FIG. 5(b) illustrates the amount of displacement of the vibration device 10 determined by simulation. In FIG. 5(b), the magnitude of displacement is represented by the density of hatching. A region with denser hatching represents a portion with a larger displacement. The displacement of the outermost lens 1 is the greatest as large as about 40 μm. The displacement of the housing 2 is the smallest as large as about 0.8 μm. The displacement of the four corners of the housing 2 with the weight is about 0.8 μm, which is about 2% with respect to the largest displacement of the outermost lens 1. Hence, a portion having a displacement of 0.8 μm or smaller, which is indicated by sparse hatching in FIG. 5(b), can satisfy the condition for a portion that can retain the cover 7. That is, the cover 7 can be retained by a portion whose displacement is smaller than or equal to a predetermined value (2% with respect to the largest displacement, for example).

As described above, a gap is provided between the cover 7 and each of the leaf spring 2a and the retainer 2b whose amount of displacement generated by the vibration of the vibrator 3 is greater than the predetermined value (2% with respect to the largest displacement, for example). The vibration device 10 includes intermediate members 71 and 72 to prevent the entry of foreign matter into this gap. The intermediate member 71 fills the gap between the cover 7 and the retainer 2b, while the intermediate member 72 fills the gap between the cover 7 and the leaf spring 2a. The intermediate members 71 and 72 thus directly contact the retainer 2b and the leaf spring 2a, respectively.

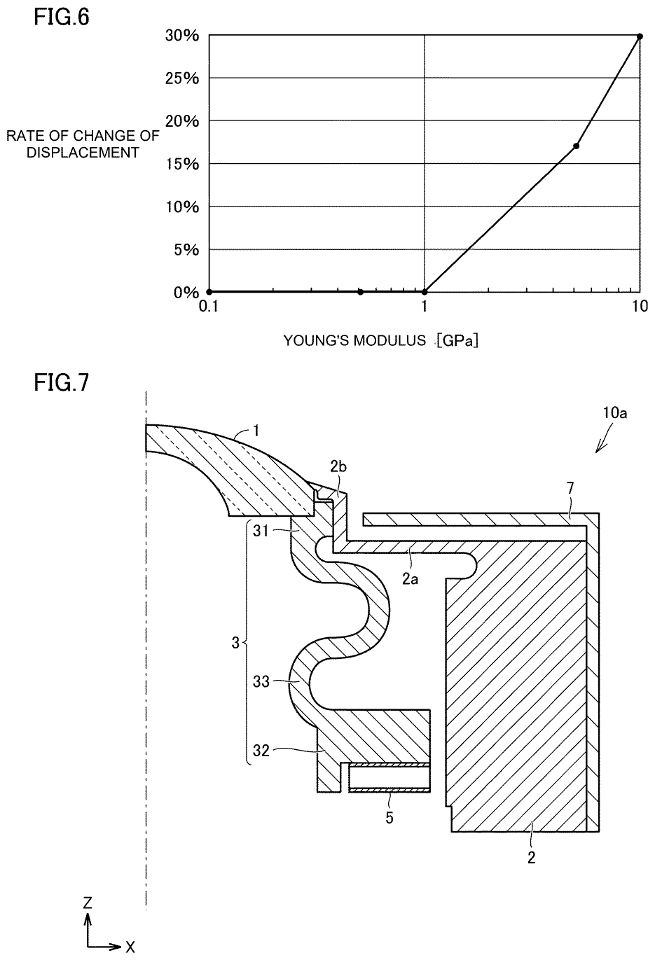

Since the intermediate members 71 and 72 directly contact the retainer 2b and the leaf spring 2a, a material having a low Young's modulus, such as rubber, resin, and sponge, that does not interfere with the vibration of the piezoelectric element 5 and does not lower the vibration performance, can be used for the intermediate members 71 and 72 in the exemplary aspect. In addition to the ability not to lower the vibration performance, the intermediate members 71 and 72 preferably have additional functions, such as waterproof, sealable (e.g., configured to enclose a space) functions. FIG. 6 is a graph for explaining the relationship between the amount of displacement of the outermost lens 1 (light-transmitting member) and the Young's modulus of the intermediate members 71 and 72. In FIG. 6, the horizontal axis indicates the Young's modulus (GPa), and the vertical axis indicates the rate of change of displacement when the displacement of the outermost lens 1 without the intermediate members 71 and 72 is 0%. As is seen from FIG. 6, if the Young's modulus of the intermediate members 71 and 72 is 1.0 GPa or lower, the displacement of the outermost lens 1 remains 0% even when the intermediate members 71 and 72 fill the gap between the cover 7 and the retainer 2b and the gap between the cover 7 and the leaf spring 2a. Hence, in the vibration device 10, if a material having a Young's modulus of 1.0 GPa or lower is used for the intermediate members 71 and 72, the intermediate members 71 and 72 do not interfere with the vibration of the piezoelectric element 5 and do not lower the vibration performance.

### First Modified Example

As illustrated in FIG. 2, in the vibration device 10, the intermediate members 71 and 72 fill the gap between the cover 7 and the retainer 2b and the gap between the cover 7 and the leaf spring 2a. However, to inhibit foreign matter from adhering to the leaf spring 2a, a vibration device may only include cover 7 in an exemplary aspect. FIG. 7 is a half-sectional view of a vibration device 10a according to a first modified example. An element of the vibration device 10a having the same configuration as that of the vibration device 10 in FIG. 2 is designated by like reference numeral and an explanation thereof will be omitted.

As shown, the vibration device 10a includes cover 7 that is arranged to have a gap to prevent direct contact with the leaf spring 2a and which is retained on the outer surface of the housing 2. The vibration device 10a is not provided with an intermediate member between the cover 7 and each of the leaf spring 2a and the retainer 2b. The cover 7 is arranged to cover the leaf spring 2a and can thus at least make it difficult for foreign matter to adhere to the leaf spring 2a.

### Second Modified Example

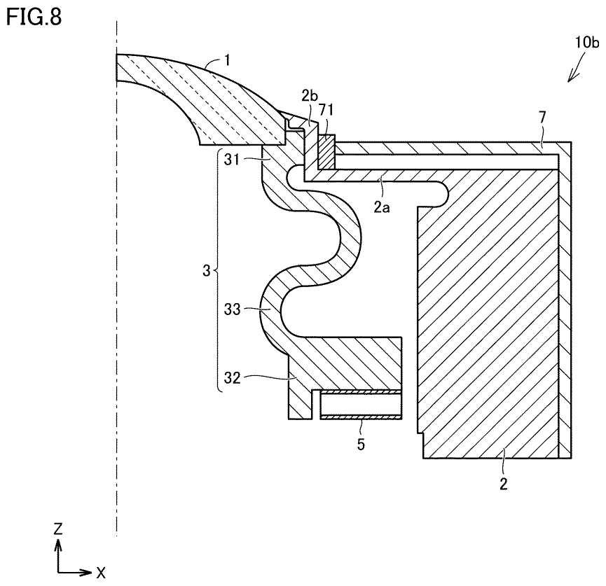

The vibration device 10a has a gap between the cover 7 and the retainer 2b, as shown in FIG. 7. Alternatively, a gap between the cover 7 and the retainer 2b may be filled. FIG. 8 is a half-sectional view of a vibration device 10b according to a second modified example. An element of the vibration device 10b having the same configuration as that of the vibration device 10 in FIG. 2 is designated by like reference numeral and an explanation thereof will be omitted.

As shown, the vibration device 10b includes a cover 7 which is arranged to have a gap to prevent direct contact with the leaf spring 2a and which is retained on the outer surface of the housing 2. The vibration device 10b is also provided with an intermediate member 71 which fills a gap between the cover 7 and the retainer 2b. Because of the provision of the intermediate member 71, the vibration device 10b can prevent the entry of foreign matter into the gap between the cover 7 and the leaf spring 2a. A material having a Young's modulus of 1.0 GPa or lower is preferably used for the intermediate member 71. The intermediate member 71 contacts the leaf spring 2a at one surface, as shown in FIG. 8, but this configuration is not essential.

### Third Modified Example

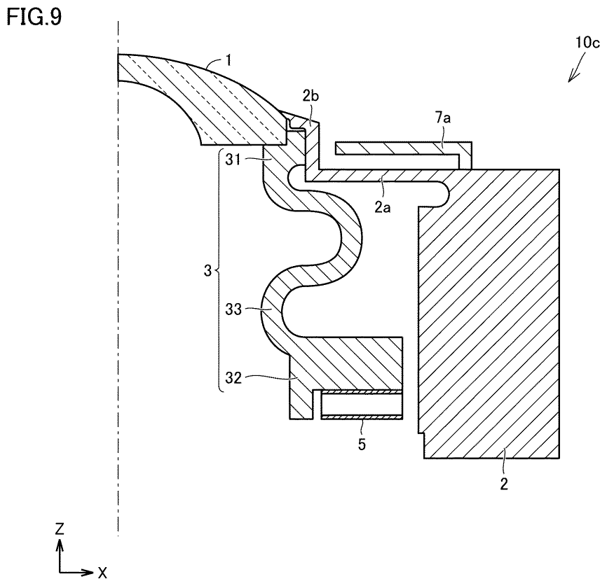

The cover 7 of the vibration device 10 is held on a side surface of the housing 2, as shown in FIG. 2. Nevertheless, if the cover 7 is held on a portion of the housing 2 whose displacement is smaller than or equal to a predetermined value (2% with respect to the largest displacement, for example), it does not interfere with the vibration of the piezoelectric element 5 and does not lower the vibration performance. FIG. 9 is a half-sectional view of a vibration device 10c according to a third modified example. An element of the vibration device 10c having the same configuration as that of the vibration device 10 in FIG. 2 is designated by like reference numeral and an explanation thereof will be omitted.

The vibration device 10c includes a cover 7a which is arranged to have a gap to prevent direct contact with the leaf spring 2a and which is retained on the top surface (e.g., the surface parallel with the leaf spring 2a) of the housing 2. As shown in FIG. 4, the displacement of the portion of the housing 2 that retains the cover 7a is smaller than or equal to the predetermined value. The cover 7a covers a portion of the leaf spring 2a whose displacement is greater than or equal to the predetermined value and makes it difficult for foreign matter to adhere to this portion. The intermediate member 71 may be provided in the gap between the cover 7a and the retainer 2b.

### Fourth Modified Example

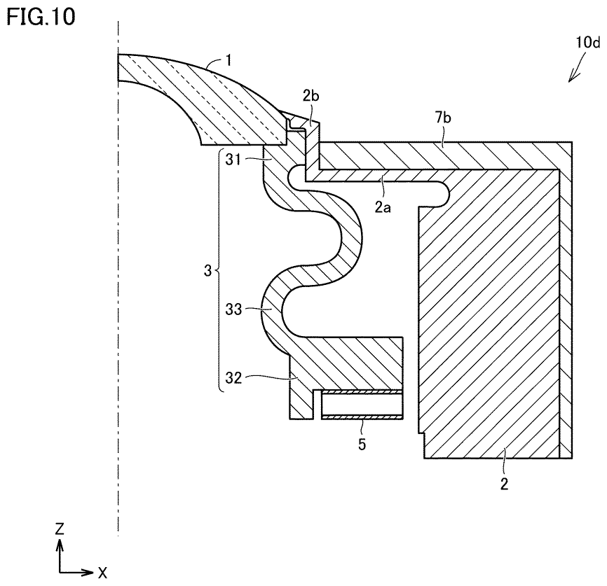

As illustrated in FIG. 2, in the vibration device 10, the intermediate members 71 and 72 fill the gap between the cover 7 and the retainer 2b and the gap between the cover 7 and the leaf spring 2a. However, the provision of a gap between the cover 7 and each of the leaf spring 2a and the retainer 2b may be omitted. FIG. 10 is a half-sectional view of a vibration device 10d according to a fourth modified example. An element of the vibration device 10d having the same configuration as that of the vibration device 10 in FIG. 2 is designated by like reference numeral and an explanation thereof will be omitted.

In this aspect, the vibration device 10d includes a cover 7b that directly contacts the leaf spring 2a. The cover 7b is in direct contact with a portion of the leaf spring 2a whose displacement is greater than the predetermined value. A material having a Young's modulus of 1.0 GPa or lower is thus used for the cover 7b. Hence, the vibration device 10d can prevent foreign matter from adhering to the leaf spring 2a by using the cover 7b and does not interfere with the vibration of the piezoelectric element 5 and does not lower the vibration performance.

### Fifth Modified Example

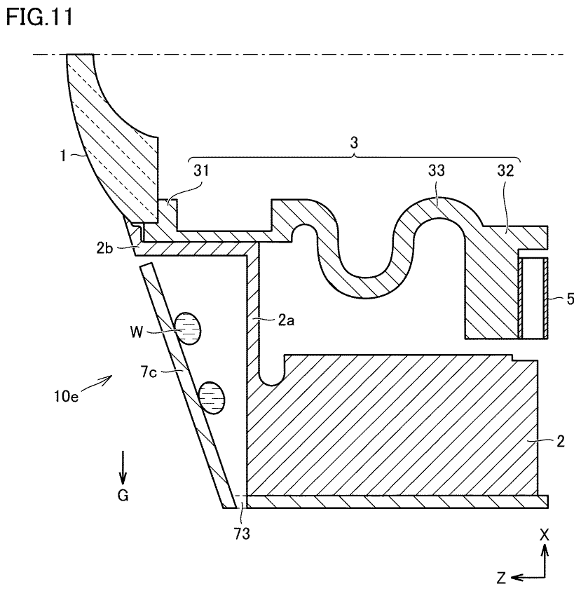

The cover 7 of the vibration device 10a is disposed in substantially parallel with the leaf spring 2a, as shown in FIG. 7. However, a cover 7 may be inclined with respect to the leaf spring 2a. FIG. 11 is a half-sectional view of a vibration device 10e according to a fifth modified example. An element of the vibration device 10e having the same configuration as that of the vibration device 10 in FIG. 2 is designated by like reference numeral and an explanation thereof will be omitted.

In this aspect, the vibration device 10e includes a cover 7c which is arranged to have a gap to prevent direct contact with the leaf spring 2a and which is retained on the outer surface of the housing 2. The cover 7c is inclined from the outermost lens 1 toward the portion retained on the housing 2, and the position of the retained portion of the cover 7c is lower than the position of the outermost lens 1 in the axial direction (Z direction) of the tubular body. Inclining the cover 7c in this manner allows foreign matter W to flow along the inner surface (e.g., surface facing the leaf spring 2a) of the cover 7c and to be discharged from a discharge port 73, as illustrated in FIG. 11.

As shown in FIG. 11, preferably, the vibration device 10e is installed on a machine (vehicle, for example) so that the axial direction (Z direction) of the tubular body is positioned at about 90 degrees with respect to the direction of the gravitational force G (downward direction in the drawing). Only a portion of the cover 7c which is positioned on the lower side when the vibration device 10e is installed on a machine may be inclined. If the vibration device 10e is configured to have the inclined cover 7c, the connecting section 31 of the vibrator 3 is preferably elongated in the axial direction of the tubular body (Z direction), as shown in FIG. 11. A water-repellent or hydrophilic coating material may be applied to the surface of the cover 7c that faces the leaf spring 2a.

### Sixth Modified Example

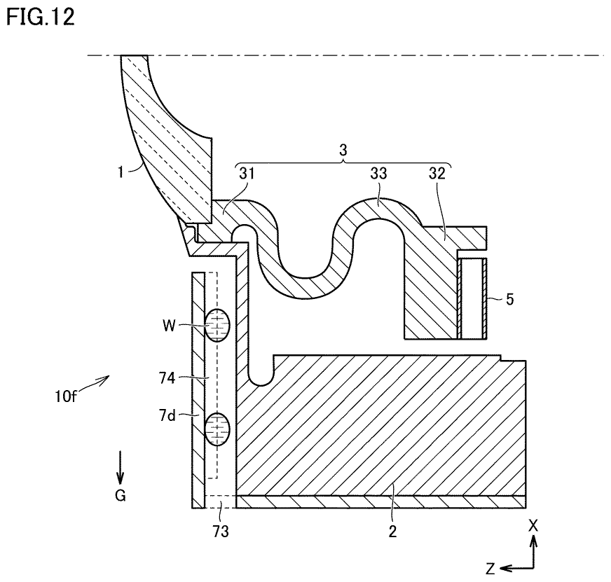

In the vibration device 10e, the cover 7c is inclined with respect to the leaf spring 2a to make it easy to discharge foreign matter, as shown in FIG. 11. Alternatively, to make it easy to discharge foreign matter, a guide portion that discharges foreign matter may be provided for a cover. FIG. 12 is a half-sectional view of a vibration device 10f according to a sixth modified example. An element of the vibration device 10f having the same configuration as that of the vibration device 10 in FIG. 2 is designated by like reference numeral and an explanation thereof will be omitted.

In this aspect, the vibration device 10f includes a cover 7d which is arranged to have a gap to prevent direct contact with the leaf spring 2a and which is retained on the outer surface of the housing 2. Irregularities are formed on the surface of the cover 7d that faces the leaf spring 2a, and a guide portion 74 is provided to discharge foreign matter. The provision of the guide portion 74 for the cover 7d allows foreign matter W to flow along the guide portion 74 and to be discharged from a discharge port 73 provided for the cover 7d, as illustrated in FIG. 12.

As shown in FIG. 12, preferably, the vibration device 10f is installed on a machine (vehicle, for example) so that the axial direction (Z direction) of the tubular body is positioned at about 90 degrees with respect to the direction of the gravitational force G (downward direction in the drawing). The guide portion 74 may be provided only for a portion of the cover 7d which is positioned on the lower side when the vibration device 10f is installed on a machine. The cover 7d may be inclined, as in the cover 7c shown in FIG. 11. A water-repellent or hydrophilic coating material may be applied to the surface of the cover 7d that faces the leaf spring 2a.

### Seventh Modified Example

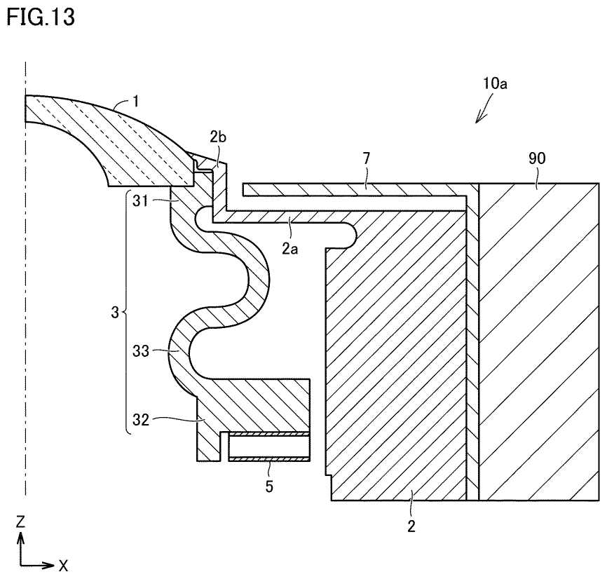

As illustrated in FIG. 7, the cover 7 of the vibration device 10a is arranged to have a gap to prevent direct contact with the leaf spring 2a and is retained on the outer surface of the housing 2. However, the cover 7 may be retained on an element other than the housing 2. FIG. 13 is a sectional view illustrating a retaining position of the cover 7.

As illustrated in FIG. 13, the cover 7 is arranged to have a gap to prevent direct contact with the leaf spring 2a and is retained on a vehicle body 90. The vehicle body 90 is part of a machine in or on which the vibration device 10a is installed. By disposing the cover 7 on the vehicle body 90, the cover 7 is retained on a portion to which the vibration of the vibration device 10a is not transmitted. The cover 7 is held between the housing 2 and the vehicle body 90.

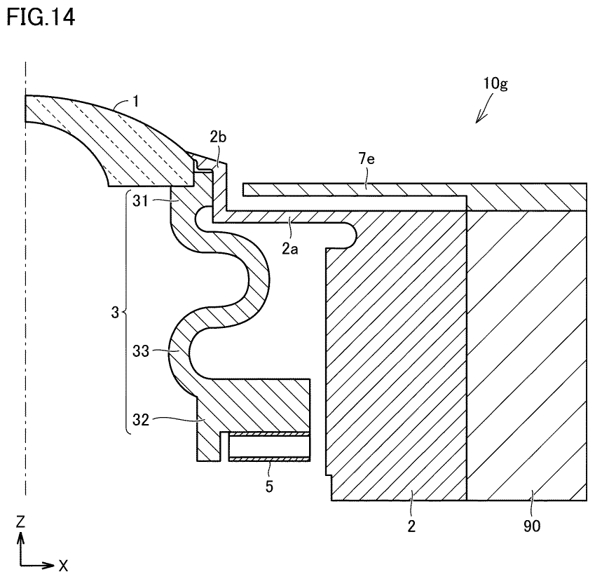

The cover 7 may be retained only on the vehicle body 90 instead of between the housing 2 and the vehicle body. FIG. 14 is a sectional view illustrating another retaining position of the cover 7. As illustrated in FIG. 14, a cover 7e is provided to have a gap to prevent direct contact with the leaf spring 2a and is retained on the vehicle body 90. The housing 2 and the vehicle body 90 are directly connected to each other. The cover 7e is retained only on the vehicle body 90.

### Second Exemplary Embodiment

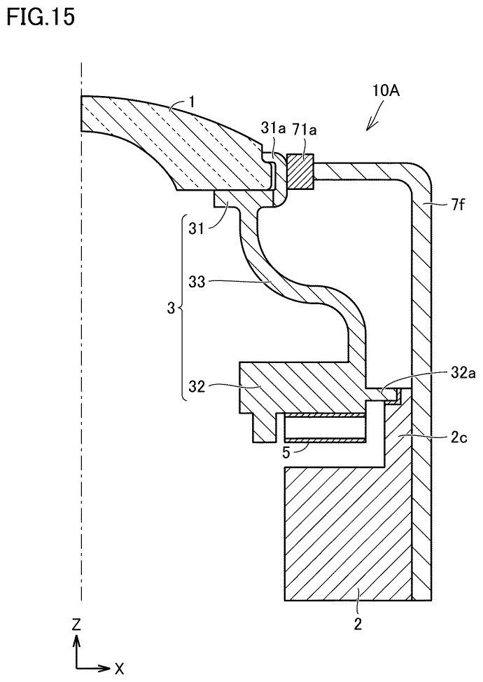

In the vibration device 10 of the first exemplary embodiment, the leaf spring 2a and the retainer 2b are an extending section extending outward from the side wall of the vibrator 3, as illustrated in FIG. 2. In a vibration device of a second exemplary embodiment, a portion directly extending from a vibrator is an extending section. FIG. 15 is a half-sectional view of a vibration device 10A according to the second exemplary embodiment. An element of the vibration device 10A having the same configuration as that of the vibration device 10 in FIG. 2 is designated by like reference numeral and an explanation thereof will be omitted. Instead of the vibration device 10 shown in FIG. 1, the vibration device 10A can be combined with the sensor device 20 to form the imaging apparatus 100.

As shown in FIG. 15, the vibrator 3 is a tubular body and includes a connecting section 31 (e.g., a first portion) that contacts the outermost lens 1, a vibrating section 32 (e.g., a second portion) that accommodates the piezoelectric element 5, and a support section 33 (e.g., a third portion) that links the connecting section 31 and the vibrating section 32.

The connecting section 31 is a cylindrical portion that contacts the bottom surface of the outermost lens 1 and transmits the vibration of the vibrator 3 to the outermost lens 1. The connecting section 31 includes a holding portion 31a to stably hold the outermost lens 1 in the radial direction (e.g., the X and Y directions) of the tubular body. The connecting section 31 and the holding portion 31a may be formed integrally or be formed separately and then combined with each other.

The vibrating section 32 is a portion that is vibrated together with the piezoelectric element 5. The vibrating section 32 is thicker than the connecting section 31 and the support section 33. On the side surface of the vibrating section 32, the vibrating section 32 includes a flange 32a (e.g., an extending section) that extends outward. The flange 32a is supported by a support section 2c of the housing 2, which can be bonded with each other by an adhesive, for example.

The piezoelectric element 5 having a hollow circular shape is vibrated in the radial direction. This vibration is converted into the vibration in the Z direction (e.g., the top-bottom direction in the drawing) by the support section 33 of the vibrator 3, thereby vibrating the outermost lens 1 in the Z direction.

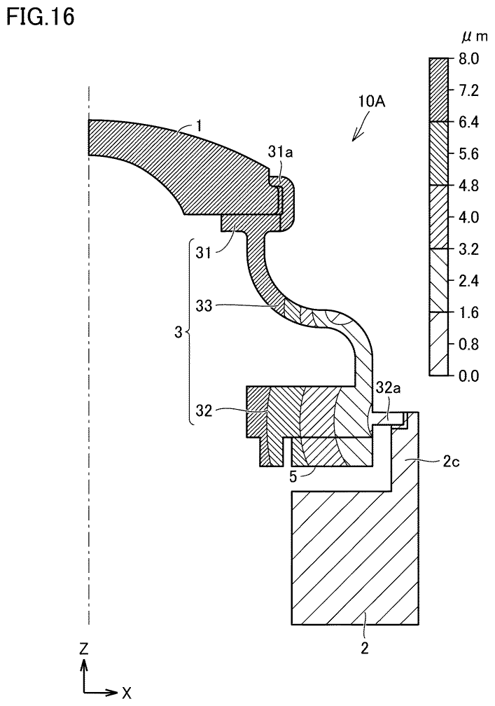

FIG. 16 is a schematic view for explaining the displacement occurring in the vibration device 10A of the second exemplary embodiment. As is seen from FIG. 16, the support section 33 is elastically deformed like a spring, so that the vibrator 3 displaces the outermost lens 1 by a considerable amount in the Z direction. As is also seen from FIG. 16, the connecting section 31, the holding portion 31a, the vibrating section 32, and the support section 33 of the vibrator 3 are also displaced considerably. In FIG. 16, the magnitude of displacement is represented by the density of hatching. A region with denser hatching represents a portion with a greater magnitude of displacement. The largest displacement occurs at the outermost lens 1, while the smallest displacement is observed at the housing 2.

As shown in FIG. 15, the vibration device 10A includes a cover 7f that covers the vibrator 3 to prevent the adhesion of foreign matter. The cover 7f is arranged to have a gap to prevent direct contact with the vibrator 3 and is retained on the outer surface (e.g., a surface perpendicular to the flange 32a) of the housing 2. The displacement of the cover 7f does not occur by the vibration of the vibrator 3, so that foreign matter does not keep remaining on the surface of the cover 7f. As a result, the vibration of the piezoelectric element 5 is not inhibited by foreign matter adhering to the cover 7f, and the vibration performance is not lowered. It is sufficient that the cover 7f can cover the vibrator 3 including at least part of the flange 32a whose displacement is larger than a predetermined value (2% with respect to the largest displacement, for example).

As further shown, a gap is provided between the cover 7f and the holding portion 31a whose amount of displacement generated by the vibration of the vibrator 3 is greater than the predetermined value. The vibration device 10A includes an intermediate member 71a to prevent the entry of foreign matter into the gap. The intermediate member 71a fills the gap between the cover 7f and the holding portion 31a. Accordingly, the intermediate member 71a directly contacts the holding portion 31a. Hence, a material having a low Young's modulus (1 GPa or lower, for example), such as rubber, resin, and sponge, is used for the intermediate member 71a so that the intermediate member 71a does not interfere with the vibration of the piezoelectric element 5 and does not lower the vibration performance. In addition to the ability not to lower the vibration performance, the intermediate member 71a preferably has additional functions, such as waterproof, sealable (e.g., configured t to enclose a space) functions.

### Modified Example

An intermediate member may be provided between the cover 7f and the vibrator 3. FIG. 17 is a half-sectional view of a vibration device 10B according to a modified example of the second exemplary embodiment. An element of the vibration device 10B having the same configuration as that of the vibration device 10A in FIG. 15 is designated by like reference numeral and an explanation thereof will be omitted.

In the vibration device 10B, the cover 7f is provided to cover the vibrator 3 to prevent the adhesion of foreign matter, as illustrated in FIG. 17. The cover 7f is arranged to have a gap to prevent direct contact with the vibrator 3 and is retained on the outer surface of the housing 2. The vibration device 10B includes intermediate members 71a and 72a to prevent the entry of foreign matter into the gaps. The intermediate member 71a fills the gap between the cover 7f and the holding portion 31a, while the intermediate member 72a fills the gap between the cover 7f and the vibrator 3. The intermediate members 71a and 72a thus directly contact the vibrator 3. Hence, a material having a low Young's modulus (1 GPa or lower, for example), such as rubber, resin, and sponge, is used for the intermediate members 71a and 72a so that the intermediate members 71a and 72a do not interfere with the vibration of the piezoelectric element 5 and do not lower the vibration performance. In addition to the ability not to lower the vibration performance, the intermediate members 71a and 72a preferably have additional functions, such as waterproof, sealable (e.g., configured to enclose a space) functions.

### Third Exemplary Embodiment

In the vibration device 10 according to the first exemplary embodiment, the intermediate members 71 and 72 fill the gap between the cover 7 and the retainer 2b and the gap between the cover 7 and the leaf spring 2a to prevent the entry of foreign matter into these gaps. The intermediate member 71 fills the gap between the retainer 2b (e.g., a side surface of the extending section) and the cover 7, while the intermediate member 72 fills the gap between the leaf spring 2a (e.g., an extending section) and the cover 7. Preferably, a material having a Young's modulus of 1.0 GPa or lower is used for the intermediate members 71 and 72 so that the intermediate members 71 and 72 do not interfere with the vibration of the piezoelectric element 5 and do not lower the vibration performance of the vibrator 3. In addition to the Young's modulus, however, the vibration performance of the vibrator 3 may also be influenced by the shape of the intermediate member that contacts the cover 7. In a third exemplary embodiment, therefore, the shape of the intermediate member that contacts the cover 7 will be examined.

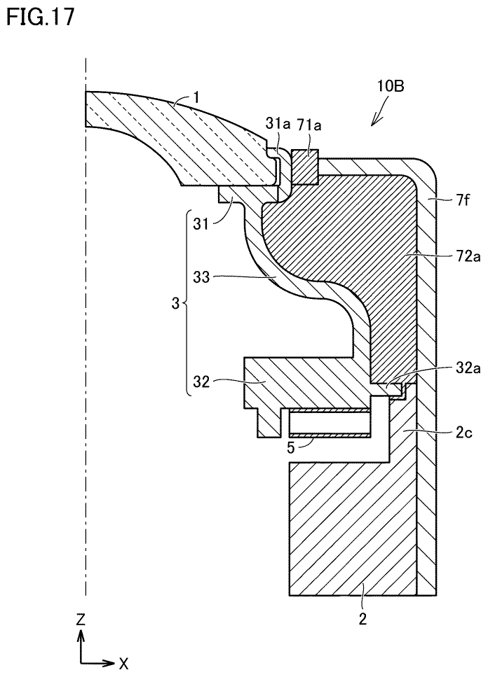

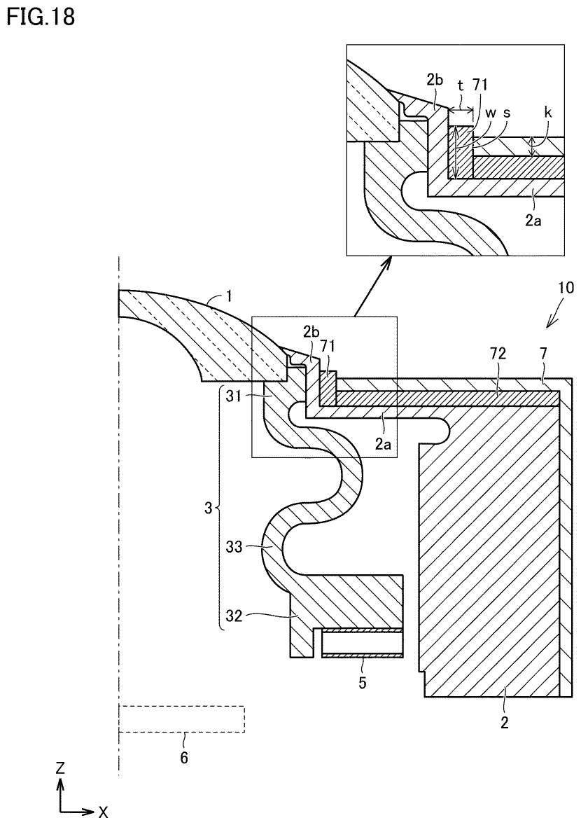

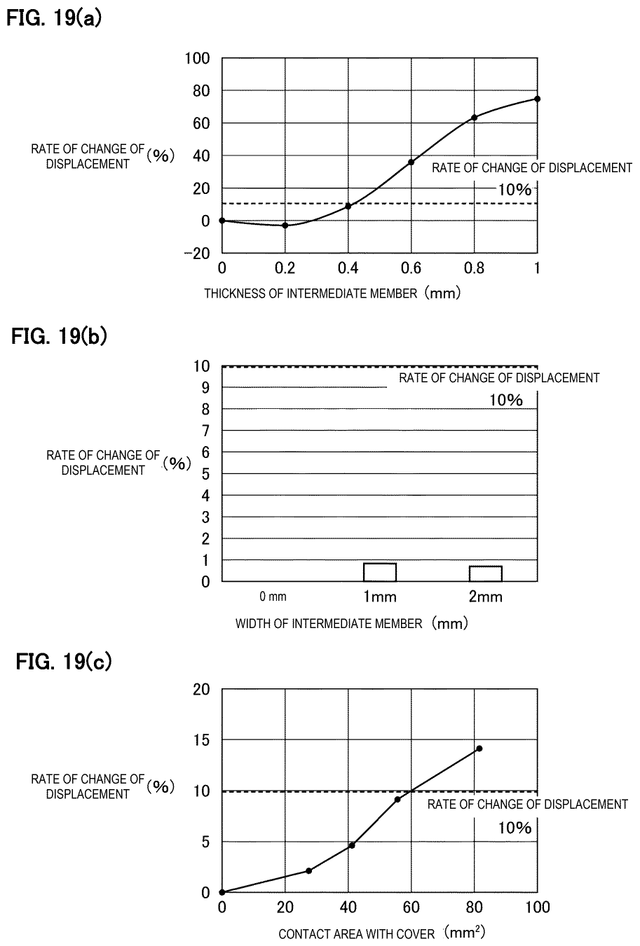

FIG. 18 is a half-sectional view of a vibration device 10 according to the third exemplary embodiment. The configuration of the vibration device 10 shown in FIG. 18 is the same as that of the vibration device 10 shown in FIG. 2. An element of the vibration device 10 in FIG. 18 identical to that of the vibration device 10 in FIG. 2 is designated by like reference numeral and an explanation thereof will be omitted. The influence of the intermediate member 71 sandwiched between the retainer 2b and the cover 7 on the vibration performance of the vibrator 3 may be greater than that of the intermediate member 72 because of the structure of the intermediate member 71, as shown in FIG. 18. The relationship between the amount of displacement of the outermost lens 1 and the shape of the intermediate member 71 will be examined. FIG. 19(a) to 19(c) show graphs for explaining the relationship between the amount of displacement of the outermost lens 1 and the dimensions of the intermediate member 71.

It is assumed, for example, that the intermediate member 71 has a thickness t (X-direction dimension), a width w (Z-direction dimension), and a contact area S with the cover 7, as illustrated in FIG. 18. The thickness t corresponds to the length (X-direction dimension) of the leaf spring 2a (extending section) in the extending direction. The contact area S can be determined by multiplying the inner circumference of the cover 7 by the thickness k of the cover 7. FIG. 19(a) shows the rate of change of displacement of the outermost lens 1 when the thickness t of the intermediate member 71 is varied. In the graph of FIG. 19(a), the horizontal axis indicates the thickness t (mm) of the intermediate member 71, and the vertical axis indicates the rate of change of displacement of the outermost lens 1 when the displacement of the outermost lens 1 of the vibration device 10 without the cover 7 is 0%. In the graph of FIG. 19(a), the width w of the intermediate member 71 is fixed to 2 mm as a precondition. As shown in FIG. 19(a), the thickness t of the intermediate member 71 is preferably 0.4 mm or smaller to limit the rate of change of displacement to 10% or lower.

FIG. 19(b) shows the rate of change of displacement of the outermost lens 1 when the width w of the intermediate member 71 is varied. In the graph of FIG. 19(b), the horizontal axis indicates the width w (mm) of the intermediate member 71, and the vertical axis indicates the rate of change of displacement of the outermost lens 1 when the displacement of the outermost lens 1 of the vibration device 10 without the cover 7 is 0%. In the graph of FIG. 19(b), the thickness t of the intermediate member 71 is fixed to 0.4 mm as a precondition. As shown in FIG. 19(b), even when the width w of the intermediate member 71 is varied to 1 mm and to 2 mm, there is almost no change in the rate of change of displacement. That is, it is found that the width w of the intermediate member 71 does not influence the vibration performance of the vibrator 3.

FIG. 19(c) shows the rate of change of displacement of the outermost lens 1 when the contact area S of the intermediate member 71 with the cover 7 is varied. In the graph of FIG. 19(c), the horizontal axis indicates the contact area S (mm²) with the cover 7, and the vertical axis indicates the rate of change of displacement when the displacement of the outermost lens 1 of the vibration device 10 without the cover 7 is 0%. In the graph of FIG. 19(c), the thickness t of the intermediate member 71 is fixed to 0.4 mm and the width w of the intermediate member 71 is fixed to 2 mm as a precondition. As shown in FIG. 19(c), the contact area S of the intermediate member 71 with the cover 7 is preferably 60 mm² or smaller to limit the rate of change of displacement to 10% or lower. For the intermediate members 71 and 72, a foam material mainly composed of polypropylene (PP), for example, is used, and the Young's modulus of this material may be 1.0 GPa or smaller or may be larger than 1.0 GPa.

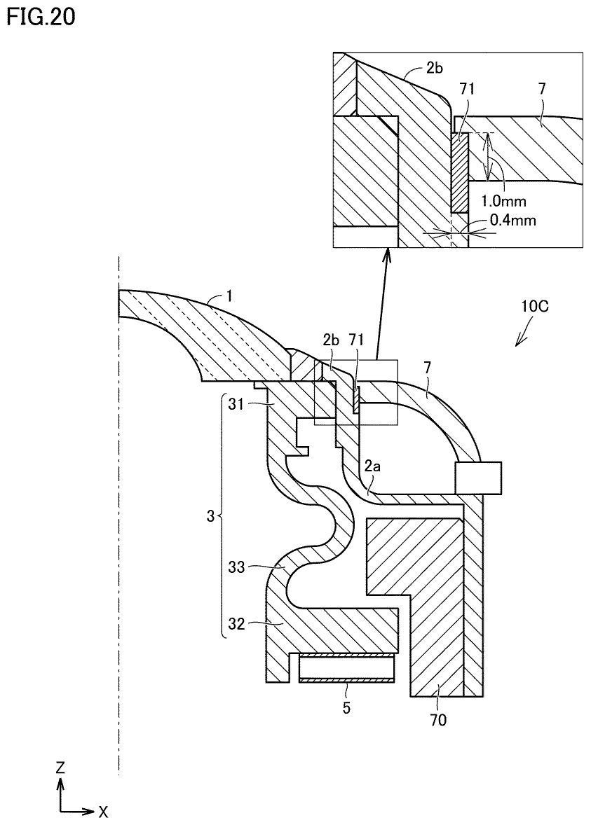

If the thickness t of the intermediate member 71 is set to 0.4 mm or smaller and the contact area S of the intermediate member 71 with the cover 7 is set to 60 mm² or smaller, the intermediate member 71 does not influence the vibration performance of the vibrator 3. This means that the width w (Z-direction dimension) of the intermediate member 71 can be increased. It is thus possible to form a cylinder-shaped vibration device with the outermost lens 1 projecting in the Z direction. FIG. 20 is a half-sectional view of a vibration device 10C according to a modified example of the third exemplary embodiment. An element of the vibration device 10C identical to that of the vibration device 10 in FIG. 2 is designated by like reference numeral and a detailed explanation thereof will be omitted.

The vibration device 10C is formed in a cylinder-like shape and the outermost lens 1 protrudes farther in the Z direction than that of the vibration device 10 in FIG. 2. More specifically, in the vibration device 10C, the leaf spring 2a extending in the X direction is folded in the Z direction in the vicinity of the vibrator 3, and the connecting section 31 of the vibrator 3 and the retainer 2b are connected to each other. Because of this configuration, the vibration device 10C is formed in a cylinder-like shape with the outermost lens 1 protruding in the Z direction. The cover 7 faces the retainer 2b with the intermediate member 71 interposed therebetween. As discussed above, the thickness t of the intermediate member 71 is set to 0.4 mm or smaller and the contact area S of the intermediate member 71 with the cover 7 is set to 60 mm² or smaller. If the Z-direction dimension of the intermediate member 71 which contacts the cover 7 is 1.0 mm and the inner circumference of the cover 7 is 55 mm, the contact area S is calculated to be 55 mm² (1.0×55=55). Since there is no limitation on the width w (Z-direction dimension) of the intermediate member 71, the intermediate member 7 can be elongated along the retainer 2b.

### Fourth Exemplary Embodiment

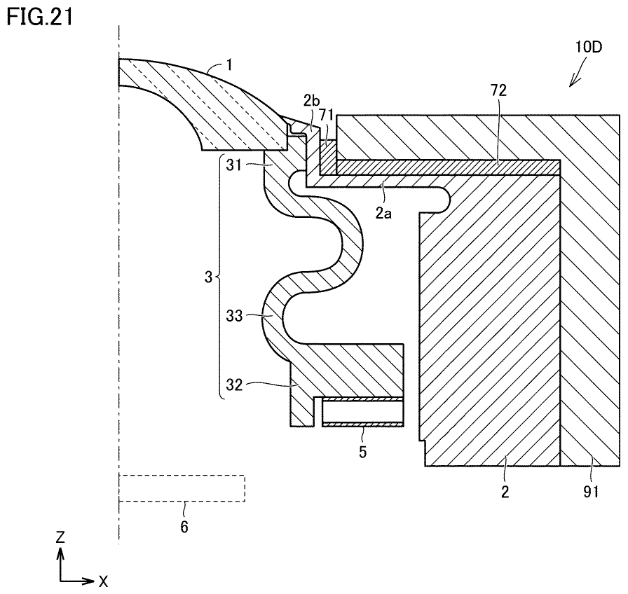

In the vibration device 10a according to the seventh modified example of the first exemplary embodiment, the cover 7 is provided on the vehicle body 90 and is connected to the housing 2. In a vibration device according to a fourth exemplary embodiment, the cover may be formed by part of the vehicle body. FIG. 21 is a half-sectional view of a vibration device 10D according to the fourth exemplary embodiment. An element of the vibration device 10D identical to that of the vibration device 10 in FIG. 2 is designated by like reference numeral and a detailed explanation thereof will be omitted.

In the vibration device 10D, as shown in FIG. 21, a portion of the housing 2 to which the vibration of the vibration device 10D is not transmitted is connected to a vehicle body 91, and part of the vehicle body 91 faces the leaf spring 2a with the intermediate member 72 interposed therebetween and faces the retainer 2b with the intermediate member 71 interposed therebetween. That is, part of the vehicle body 91 serves as the cover 7 shown in FIG. 2. Hence, the vibration device 10D can be configured without a cover. The vibration frequency of the vehicle body 91 when the vehicle is running is about 1 to 100 Hz. Even if the vibration of the vehicle body 91 is transmitted to the vibration device 10D via part of the vehicle body 91 that serves as the cover, the vibration frequency is considerably different from the resonant frequency of the vibration device 10D. Thus, the vibration of the vehicle body 91 does not influence the vibration performance.

### Fifth Exemplary Embodiment

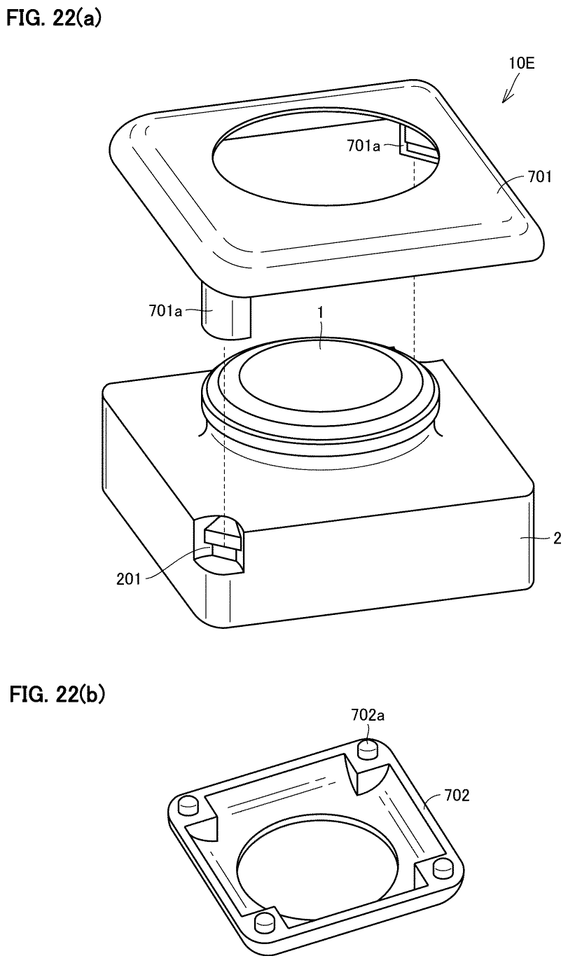

In the vibration device 10 according to the first exemplary embodiment, the cover 7 is provided to cover the leaf spring 2a. In a fifth exemplary embodiment, a fixing method of the cover to the housing will be discussed in detail. FIG. 22(a) and 22(b) show perspective views of a vibration device 10E according to the fifth exemplary embodiment. An element of the vibration device 10E identical to that of the vibration device 10 in FIG. 1 is designated by like reference numeral and a detailed explanation thereof will be omitted.

In the vibration device 10E, a cover 701 is mounted on the housing 2, as shown in FIG. 22(a). Retaining claws 701a are provided at two opposing corners of the cover 701. Stoppers 201 are provided for the housing 2 at the positions corresponding to the retaining claws 701a. The retaining claws 701a and the stoppers 201 are fit into each other, thereby fixing the cover 701 to the housing 2. In the vibration device 10E, the number and the positions of the retaining claws 701a to be provided for the cover 701 are not limited to those shown in FIG. 22(a). It should be appreciated that the number and the positions of the stoppers 201 to be provided for the housing 2 are based on the retaining claws 701a provided for the cover 701.

FIG. 22(b) shows a cover 702 provided with press-fitting projections 702a instead of retaining claws. The projections 702a are provided at the four corners of the cover 702. Receiving portions are provided for the housing 2 at the positions corresponding to the projections 702a, though they are not shown. The number and the positions of the projections 702a to be provided for the cover 702 are not limited to those in FIG. 22(b). The number and the positions of the receiving portions to be provided for the housing 2 are determined by those of the projections 702a provided for the cover 702.

To mechanically fix the cover to the housing (to the vibration device), a set of the retaining claws 701a and the stoppers 201 or the press-fitting projections 702a may be employed as discussed above, and screws may also be used. Alternatively, an adhesive may be used to fix the cover to the housing.

### Additional Exemplary Aspects

In general, it is noted that the configurations of the vibration devices according to the above-described exemplary embodiments and modified examples may be combined with other in a suitable manner. For example, the cover 7f of the second exemplary embodiment may be retained on the vehicle body 90 shown in FIG. 13.

In the vibration devices of the above-described exemplary embodiments, the cross-sectional shape of the support section 33 is an S-shape. However, if the support section 33 is formed in a shape that does not cause stress concentration on the vibrator, the cross-sectional shape of the support section 33 is not limited to an S-shape. For example, the cross-sectional shape of the support section 33 may be a shape formed by connecting multiple S-shapes or a curved shape that is half of an S-shape.

The imaging apparatus according to the above-described exemplary embodiments may include another element, such as a camera, LiDAR, and Radar. Multiple imaging apparatuses may be arranged side by side as would be appreciated to one skilled in the art.

It is also noted that the imaging apparatus according to the above-described exemplary embodiments is not limited to that mounted on a vehicle. The imaging apparatus may be applicable to any imaging apparatus that includes an optical instrument and an imaging device, which is arranged such that a light-transmitting member is positioned in the viewing direction of the imaging device, and that needs removing foreign matter adhering to the light-transmitting member.

In general, it is noted that the disclosed embodiments are provided only for the purposes of illustration, but are not intended to be exhaustive or to limit the disclosure to the precise forms disclosed. The scope of the disclosure is to be accorded the broadest interpretation so as to encompass all such modifications and equivalent structures and functions.

### REFERENCE SIGNS LIST

1 outermost lens, 2 housing, 2a leaf spring, 2b retainer, 3 vibrator, 5 piezoelectric element, 6 imaging device, 8 bracket, 10 vibration device, 20 sensor device, 31 connecting section, 32 vibrating section, 33 support section, 71, 71a, 72, 72a intermediate member, 73 discharge port, 74 guide portion, 90 vehicle body, 100 imaging apparatus

What is claimed:

1. A vibration device comprising:
a light-transmitting member configured to transmit light;
a vibrator that contacts the light-transmitting member and is configured to vibrate the light-transmitting member, the vibrator comprising a tubular body;
a piezoelectric element disposed at the vibrator;
an extending section that extends outward from a side wall of the vibrator; and
a cover that covers the vibrator and at least part of the extending section.

2. The vibration device according to claim 1, wherein the extending section comprises a leaf spring and a retainer.

3. The vibration device according to claim 1, wherein a gap is provided between the cover and a portion of the vibrator and a portion of the extending section.

4. The vibration device according to claim 3, wherein an amount of displacement of the portion of the vibrator and the portion of the extending section occurring by vibration of the vibrator is greater than a predetermined value, and the cover is retained on a portion having an amount of displacement occurring by the vibration of the vibrator is smaller than or equal to the predetermined value.

5. The vibration device according to claim 4, further comprising an intermediate member in a gap between at least one of the cover and the vibrator and between the cover and the extending section, the intermediate member having a Young's modulus that is 1 GPa or lower.

6. The vibration device according to claim 4, further comprising an intermediate member in a gap between at least one of the cover and the vibrator and between the cover and the extending section, the intermediate member having a dimension in an extending direction of the extending section that 0.4 mm or smaller.

7. The vibration device according to claim 4, further comprising an intermediate member in a gap between at least one of the cover and the vibrator and between the cover and the extending section, the intermediate member having a contact area with the cover that is 60 mm² or smaller.

8. The vibration device according to claim 4, wherein the cover is inclined in a direction from the light-transmitting member toward a retained portion of the cover.

9. The vibration device according to claim 8, wherein a position of the retained portion of the cover is lower than a position of the light-transmitting member in an axial direction of the tubular body of the vibrator.

10. The vibration device according to claim 4, wherein a surface of the cover that faces the vibrator or the extending section comprises irregularities, and a guide portion configured to discharge foreign matter is provided for the cover.

11. The vibration device according to claim 9, further comprising a water-repellent or hydrophilic coating material on a surface of the cover that faces the vibrator or the extending section.

12. The vibration device according to claim 10, further comprising a water-repellent or hydrophilic coating material on a surface of the cover that faces the vibrator or the extending section.

13. The vibration device according to claim 1, wherein the cover is retained on part of a machine in or on which the vibration device is installed.

14. The vibration device according to claim 1, wherein the cover is part of a machine in or on which the vibration device is installed.

15. The vibration device according to claim 1, wherein the cover is fixed to the vibration device mechanically or using an adhesive.

16. The vibration device according to claim 1, wherein the cover contacts at least a portion of the vibrator and a portion of the extending section, an amount of displacement of the portion of the vibrator and the portion of the extending section that occurs by vibration of the vibrator is greater than a predetermined value, and the cover comprises a material having a Young's modulus of 1 GPa or lower.

17. The vibration device according to claim 1, wherein the tubular body of the vibrator includes a connecting section that contacts a lens of the light-transmitting member, a vibrating section that accommodates the piezoelectric element, and a support section that links the connecting section to the vibrating section.

18. The vibration device according to claim 17, wherein the support section comprises an S-shaped cross section.

19. The vibration device according to claim 17, wherein the connecting section directly connects the lens to a retainer of the extending section.

20. An imaging apparatus comprising:
the vibration device according to claim 1; and
an imaging device that is configured such that the light-transmitting member is positioned in a viewing direction of the imaging device.
